(19) United States
(12) Patent Application Publication
(10) Pub. No.: US 2022/0172118 A1
(43) Pub. Date: Jun. 2, 2022

(54) SYSTEM AND A METHOD OF ASSESSING DATA CORRESPONDING TO PERFORMANCE OF A PLAYER PLAYING A SPORT AND PROVIDING RECOMMENDATIONS FOR IMPROVING THE PERFORMANCE

(71) Applicants: Satyajit Sadanandan, Krasnogorsk (RU); Marina Gubochkina, Krasnogorsk (RU)

(72) Inventors: Satyajit Sadanandan, Krasnogorsk (RU); Marina Gubochkina, Krasnogorsk (RU)

(21) Appl. No.: 17/520,111

(22) Filed: Nov. 5, 2021

(30) Foreign Application Priority Data
Nov. 7, 2020 (IN) 202041043568

(51) Int. Cl. G06N 20/00; G06K 9/62; A63B 71/06

(52) U.S. Cl. CPC G06N 20/00; G06K 9/6235; G06K 2009/6237; A63B 2071/0675; A63B 71/06

(57) ABSTRACT

A system and a method of assessing data corresponding to performance of a player playing a sport/game and providing recommendations for improving the performance are disclosed. The system presents a set of questionnaires corresponding to a first set of elements and a second set of elements to a user. The first set of elements correspond to personality and the second set of elements correspond to an ecosystem of a player or user playing/interested in a sport/game/play. The user provides responses using a user device. The system receives the responses and maps each of the responses with predetermined parameters having weightages. The system determines a score for each of the first set of elements and the second set of elements based on the mapping and assesses the skill, personality and ecosystem of the player. Further, the system presents an aggregate score based on the score for each of the first and second set of elements. The system provides recommendations to the user to improve the game based on the assessment.

### CROSS-REFERENCE TO RELATED APPLICATIONS

The present application claims priority from an Indian Provisional Patent Application Ser. No. 202041043568, filed on Nov. 7, 2020, which is incorporated herein by its entirety and referenced thereto.

### FIELD OF INVENTION

The present invention generally relates to a field of computing devices facilitating sports performance improvement services. More specifically, the present invention provides a system and a method for talent improvement/performance development of sports players by conducting a multi-dimensional assessment of each player and giving them personalized feedback for improvement.

### BACKGROUND OF THE INVENTION

Children and adults alike enjoy playing a variety of sports. The sports may include, but not limited to, soccer/football, volleyball, basketball, field hockey, tennis, cricket, badminton, table tennis, golf, baseball, American football, ice hockey and so on. People play sports for multiple reasons such as for the love of competition, to release stress, to enjoy social recreation and entertainment. Each sport requires a player to have skills and techniques to play the sport. For example, soccer is a team sport in which each of two teams' attempts to place a ball in the goal of the opposing team. Players of the opposing team attempt to maneuver the ball downfield and into the goal of the opposing team by kicking the ball. The players require skills to pass, trap the ball and shoot the ball into the goal with confidence and control, which can only be acquired with practice and/or training.

Players generally train in sports academies and training centers. Many sports academies and training centers gauge and develop player's skills through techniques of observing players such as skills—both technical and tactical, physical and mental/personality aspects during the game and build interventions to improve in these areas.

Several methods have been disclosed in the past to assess the performance of the players and provide recommendations. One such example is disclosed in a United States Patent Publication No. 20150178325, entitled, “System for providing access over a network to users of training preferences of selected individuals”, (“the '325 Publication”). The '325 Publication discloses a system and method for collecting and sharing publicly recognized athlete's nutritional, physical, mental and/or other key practices during a specific period of time and providing the scientific and practical rationale for said practices. The system includes software that enables users to access specific publicly recognized athlete's profiles and view the personal histories of their favourite athletes and learn what they eat, what warm up and cool down practices they do, their mental focusing techniques and other key practices. Users can also use the application to track their own game schedules and view publicly recognized athletes' twitter feeds. The application also enables users to build their own profile by combining the habits of athletes that they have selected. The invention allows users to have an all-in-one system with nutritional, physical, mental and other routines, connecting to their favourite athletes and a game scheduler.

Another example is disclosed in a United States Patent Publication No. 20120144301, entitled, “Method and system for a virtual training and coaching service”, (“the '301 Publication”), The '301 Publication discloses a method and system using an online website that provides personalized and comprehensive fitness, nutrition, motivation, and training information to registered users, typically without directing them to other sites or requiring the purchase of products. The invention provides an interactive, easy to use, personalized homepage for each user. The user has access to selectable Modules focused on different areas of fitness which open within the personalized homepage to help them improve general fitness ability, strength, speed, agility and flexibility or aid in prevention of and recovery from injuries while providing nutritional guidance, injury prevention and treatment tips, and/or coaching instructions.

Although the above discussed disclosures are effective, they have few problems. For instance, the techniques used in the existing art do not account for the large number of variables in the personality and ecosystem of the players that are not directly observable through the game but are crucial to ensure long-term success. Further, the existing art does not consider attitude, behavior of the players and other elements during and after playing the sport. As a result, existing art does not consider a large number of variables that help to determine the skill/potential and improve the player's skill/potential and techniques. In other words, a large number of variables involved in determining a successful path to the sport has made the process of predicting the potential/future performance of players very unreliable. This limits the sports academies and training centers to reliably predict the potential of the player.

Therefore, there is a need for a system and a method for improving performance of a player considering the complexity of the relationships between a variety of variables that determine a successful path for the player to improve his skill/potential.

### SUMMARY OF THE INVENTION

The problems in the existing art are met by a system and a method of assessing data corresponding to potential and performance of a player playing a sport/game and providing recommendations.

Accordingly, it is an object of the present invention to provide a system and a method of assessing data corresponding to potential and performance of a player playing a sport/game and providing recommendations for improving the performance, and that avoids the drawback of known techniques used by sports academies and training centers.

It is another object of the present invention to provide a system that can be used to assess potential and performance of a player playing any sport such as individual sports or team sports and provide recommendations for improving in the sport.

In order to achieve one or more of the objects as stated above, the present invention provides a system for assessing data corresponding to potential and performance of a player playing a sport/game and providing recommendations for improving the performance. The system presents a set of questionnaires corresponding to at least two sets of elements i.e., a first set of elements and a second set of elements. The first set of elements correspond to personality, and the second set of elements correspond to an ecosystem of a player playing/interested in a sport/game/play. The user provides responses using a user device such as a mobile phone or desktop or laptop computer. The system receives the responses and maps each of the responses with predetermined parameters having different weightages. The system determines a score for each of the first set of elements and the second set of elements based on the mapping and assesses personality and ecosystem of the player. Further, the system presents an aggregate score based on the score for each of the first and second set of elements. The system provides recommendations to the user to improve the game based on the assessment.

In one advantageous feature of the present invention, the system identifies various interlinked elements in the personality and ecosystem of the player that lead to success in the sport, the relative importance of these variable elements, their cross-linkages and the intervention strategies in all the different areas that are needed based on the assessment to ensure higher chances of success. The system helps to predict and develop players by identifying their weaknesses and strengths based on their personality and ecosystem in addition to their infield skills and techniques. The system helps to consider a variety of variables including, but not limited to, attitude, behavior of the players and many diverse elements in their sporting and non-sporting environment. This helps to determine a successful path to the sport in predicting and training reliable players.

The system acts as an assessment and feedback tool for aspiring sports players to overcome the gaps in their personality and ecosystem that are relevant to their development needs in their sport. The system includes self-administrable questionnaires consisting of various questions on the player. Each question has a quantified response and the resulting scores are used to generate a detailed feedback report or recommendation report for each player based on their responses.

Further advantages and examples of the invention will be brought out in the following part of the specification, wherein detailed description is for the purpose of fully disclosing the invention without placing limitations thereon.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates an environment of a system for assessing data corresponding to performance of a player playing a sport/game and providing recommendations for improving the performance, in accordance with one embodiment of the present invention;

FIG. 2 illustrates a block diagram of the system;

FIG. 3 illustrates a block diagram of a user device operated by a user, in accordance with one embodiment of the present invention;

FIG. 4 illustrates a spider graph/chart showing first set of elements and second set of elements, in accordance with one exemplary embodiment of the present invention; and

FIG. 5 illustrates a method of assessing data corresponding to performance of a player playing a sport/game and providing recommendations for improving the performance, in accordance with one embodiment of the present invention.

### DETAILED DESCRIPTION OF THE INVENTION

The following detailed description is susceptible to various modifications and alternative forms, specific embodiments thereof will be described in detail and shown by way of example. It should be understood, however, that there is no intent to limit example embodiments of the present invention to the particular forms disclosed. Conversely, example embodiments are to cover all modifications, equivalents, and alternatives falling within the scope of the invention.

It should be understood that, although the terms first, second, etc. may be used herein to describe various elements, these elements are not limited by these terms. These terms are only used to distinguish one element from another. For example, a first element could be termed a second element, and, similarly, a second element could be termed a first element, without departing from the scope of the present invention.

The terminology used herein is for the purpose of describing particular embodiments only and is not intended to limit the invention. As used herein, the singular forms “a,” “an,” and “the” are intended to include the plural forms as well, unless the context clearly indicates otherwise. It should be further understood that the terms “comprises,” “comprising,” “includes,” “including,” and/or “having” specify the presence of stated features, integers, steps, operations, elements, and/or components when used herein, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It should be further understood that terms, e.g., those defined in commonly used dictionaries, should be interpreted as having a meaning that is consistent with their meaning in the context of the relevant art and are not to be interpreted in an idealized or overly formal sense unless expressly so defined herein.

It should also be noted that in some alternative implementations, functions/acts noted in a specific block may occur out of the order noted in a flowchart. For example, two blocks shown in succession may in fact be executed substantially concurrently or may sometimes be executed in a reverse order depending upon functionality or acts involved.

It should be understood that the present invention describes a system for assessing data corresponding to performance of a player playing a sport and providing recommendations for improving the performance. The system presents questionnaire to users corresponding to a first set of elements and a second set of elements. The system receives responses for the first set of elements and the second set of elements from a player via a user device. The system maps the responses with predetermined parameters. The responses are mapped by assigning weightages for each of the predetermined parameters. The system calculates a feature value of the player corresponding to the responses and the weightages assigned. The system calculates a benchmark score of the player, wherein the benchmark score is calculated as a function of feature value of the player distant from an elite player in the sport. The system correlates the benchmark score against a benchmark threshold to obtain deviation of the benchmark score from the benchmark threshold. The system provides recommendations to the player based on the deviations in order to improve performance of the game.

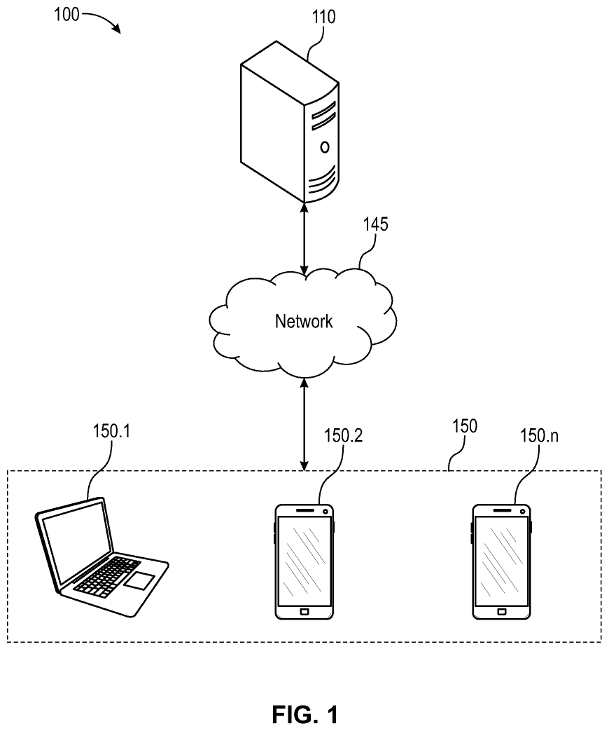

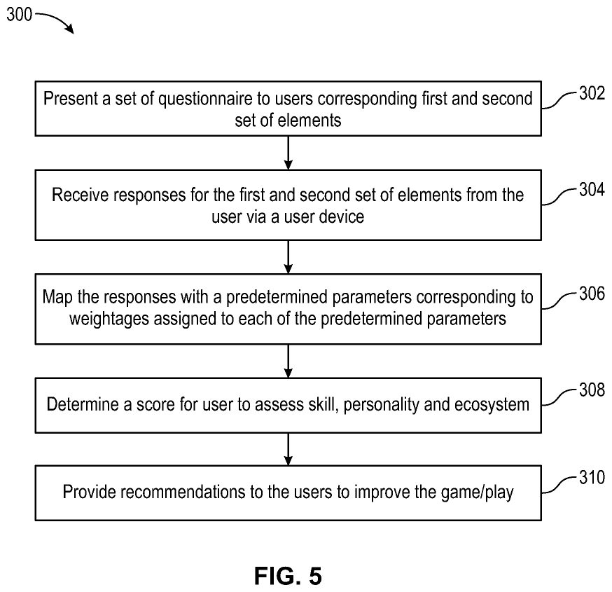

Various features and embodiments of the system for assessing data corresponding to performance of a player playing a sport/game and providing recommendations for improving the performance are explained in conjunction with the description of FIGS. 1-5.

In one embodiment, the present invention discloses a system for assessing data corresponding to performance of a player playing a sport/game and providing recommendations for improving the performance. FIG. 1 shows an environment 100 in which a system 110 for assessing data corresponding to performance of a player playing a sport/game and providing recommendations for improving the performance implements, in accordance with one embodiment of the present invention. The system 110 communicatively connects to a plurality of user devices 150. 1, 150. 2 . . . 150.n, collectively referred to as user devices 150. Each of the system 110 and the plurality of user devices 150 communicatively connect via a network 145.

The system 110 may include a server or a database comprising an application to execute functions for assessing data corresponding to performance of a player playing a sport/game and providing recommendations for improving the performance. In one embodiment, the system 110 may operate as a standalone device or connect to other (e.g., networked) systems. A person skilled in the art appreciates that the system 110 may implement in any different computing systems, environments, and/or configurations such as a workstation, an electronic device, a mainframe computer, a laptop, and so on. In a networked deployment, the system 110 may operate in the capacity of a server or a client machine in server-client network environment, or as a peer machine in a peer-to-peer (or distributed) network environment.

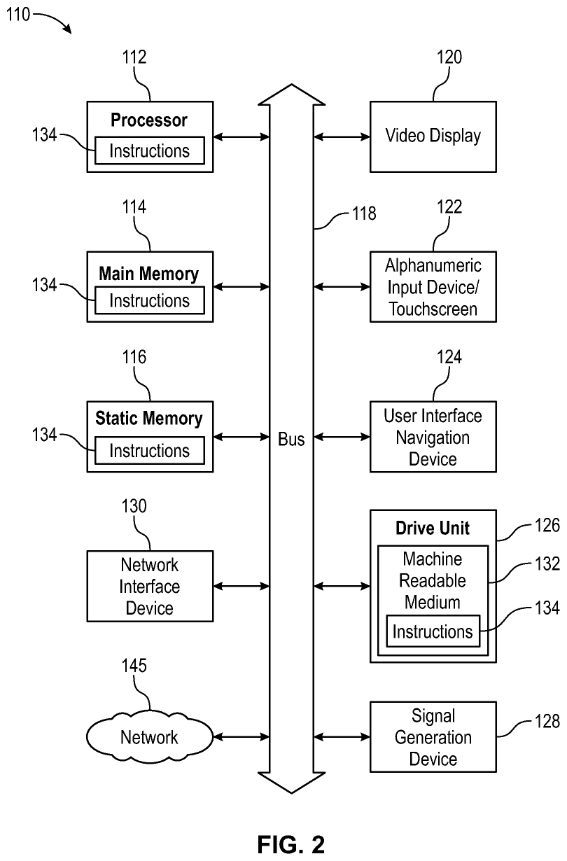

FIG. 2 shows a diagrammatic representation of the system 110, in accordance with one embodiment of the present invention. The system 110 comprises a processor 112 (e.g., a central processing unit (CPU), a graphics processing unit (GPU) or both), a main memory 114 and a static memory 115, which communicate with at least one other via a bus 118. The system 110 further comprises a video display unit 120 (e.g., a liquid crystal display (LCD) or a cathode ray tube (CRT)). The system 110 further comprises an alphanumeric input device (e.g., a keyboard) and/or a touchscreen 122, a user interface (UI) navigation device 124 (e.g., a mouse), a disk drive unit 126, a signal generation device 128 (e.g., a speaker) and a network interface device 130.

The disk drive unit 126 includes a machine-readable medium 132 on which is stored one or more sets of instructions and data structures (e.g., software 134) embodying or utilized by any one or more of the methodologies or functions described herein. It should be understood that the term “machine-readable medium” might be taken to include a single medium or multiple medium (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” may accordingly be taken to include, but not be limited to, solid-state memories, optical and magnetic media, and carrier wave signals.

The instructions 134 may also reside, completely or at least partially, within the main memory 114 and/or within the processor 112 during execution thereof by the system 110, the main memory 114 and the processor 112 also constituting machine-readable media. The instructions 134 may further be transmitted or received over the network 145 via the network interface device 130 utilizing any one of a number of well-known transfer protocols.

The network 145 may be a wireless network, a wired network or a combination thereof. Network 145 can be implemented as one of the different types of networks, such as intranet, local area. network (LAN), wide area network (WAN), the internet, and the like. The network 145 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 145 may include a variety of network devices, including routers, bridges, servers, computing devices, storage devices, and the like.

In accordance with the one embodiment of the present subject, one or more of the user devices 150 may access the data stored and processed by the system 110. The user devices 150 may include, but not limited to, a mobile phone, a laptop, a desktop computer, a tablet, a wrist watch and other electronic devices. In one example, a user such as a player or his/her parent or a coach may operate the user device 150 to access data stored and processed by the system 110.

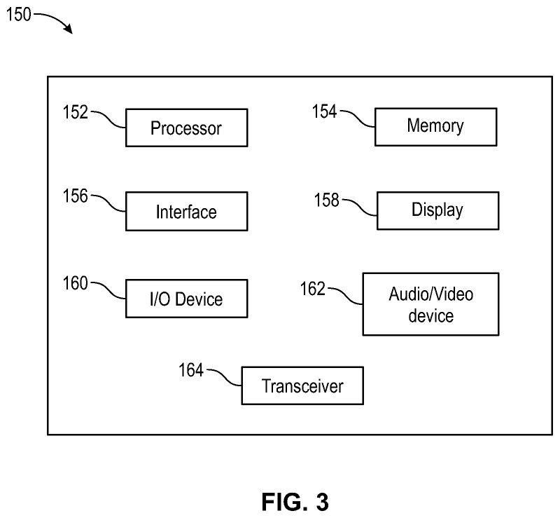

FIG. 3 shows a block diagram of a user device 150, in accordance with one embodiment of the present invention. Each of the user devices 150 may include at least one processor 152. The at least one processor 152 may include one or more commonly known CPUs such as microprocessor or microcontroller. It should be understood that at least one processor 152 might be responsible for implementing specific functions under the control of software including an operating system, and any appropriate applications software.

Each of the user devices 150 may include a memory 154 such as a volatile memory (e.g., RAM), non-volatile memory (e.g., disk memory, FLASH memory, EPROMs, etc.), unalterable memory, and/or other types of memory. In one implementation, the memory 154 might be configured or designed to store data, program instructions. The program instructions might control the operation of an operating system and/or one or more applications.

Each of the user devices 150 may include interface(s) 156. The interface 156 may include wired interfaces and/or wireless interfaces. In at least one implementation, the interface(s) 156 may include functionality similar to at least a portion of functionality implemented by one or more computer system interfaces such as those described herein and/or generally known to one having ordinary skill in the art.

Each of the user devices 150 may include display(s) 158. The display(s) 158 may be implemented using LCD display technology, OED display technology, and/or other types of conventional display technology.

Each of the user devices 150 may include one or more user I/O Device(s) 170. The one or more user I/O Device(s) 160 may include keys, buttons, scroll wheels, cursors, touchscreen sensors, audio command interfaces, magnetic strip reader, optical scanner, etc.

Each of the user devices 150 may include Audio/Video device(s) 162. The Audio/Video devices) 162 includes components for displaying audio/visual media. For example, the Audio/Video device(s) 162 may include cameras, speakers, microphones, media presentation components, wireless transmitter/receiver devices for enabling wireless audio and/or visual communication between the user device 150 and the system 110 and other remote devices (e.g., radios, telephones, computer systems, etc.).

Each of the user devices 150 may include wireless communication module(s)/transceiver 164. The transceiver 164 may be configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

As specified above, the system 110 facilitates in assessing data corresponding to performance of a player playing a sport/game and providing recommendations for improving the performance. As such, the system 110 implements in an online environment in which users of the user devices 150 access data stored and processed by the system 110. As specified above, a user may include a player himself/herself, a parent of the player, a coach of the player(s) or any other player associated with a player or group of players (team). The user of the user device 150 accesses the system 110 to assess and receive recommendation based on his performance. In order to access the system 110, the user registers with the system 110. The user may register with the system 110 by providing details such as name, address, age, sex, weight, height, school, club, sport he/she interested in, his skills, experience, electronic contact information payment information (e.g., credit cards, electronic wallets, commercial payment accounts, etc.), and so on.

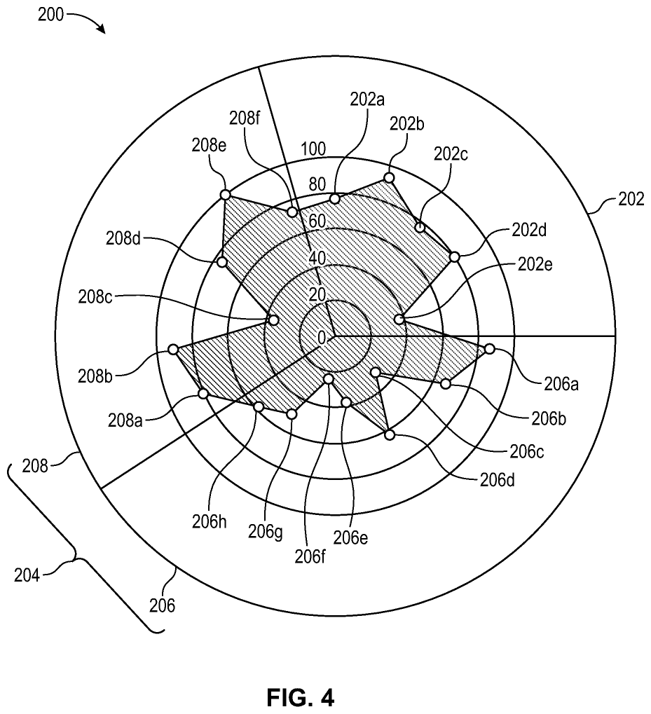

In order to assess data corresponding to performance of a player playing a sport/game and provide recommendations, at first, the system 110 is preconfigured with a plurality of elements. The plurality of elements indicates variables that are indicative of attitude, behavior, learning style and aspects corresponding to the sporting and non-sporting environment of the player influencing the skill, practice and training of the player in playing the sport. Here, the sport may include, but not limited to, soccer/football, volleyball, basketball, field hockey, tennis, cricket, badminton, table tennis and so on. In one example, the plurality of elements comprises two set of elements such as a first set of elements and a second set of elements. A person skilled in the art appreciates that the system 110 may process more than two set of elements for providing recommendations to the player using the features disclosed herein and such an implementation falls within the scope of the presently disclosed invention. The first set of elements may indicate elements that correspond to the personality of a player. The second set of elements may indicate elements that correspond to ecosystems and/or surroundings of the player that impact the player's game. FIG. 4 shows a spider graph/chart 200 illustrating a first set of elements 202 and a second set of elements 204 that make an impact on the player's game, in accordance with one exemplary embodiment of the present invention. As specified above, the first set of elements 202 correspond to the personality of a player. As such, the first set of elements 202 may include, hut not limited to, passion 202a, perseverance 202b, and so on. Passion 202a may indicate a player's desire or enthusiasm for learning new skills and techniques of the sport. Perseverance 202b may indicate a player's commitment to achieve the desired goal in the sport. Ownership 202c may indicate a player's ability to own or take up responsibility to achieve the desired goal in the sport. Self-efficacy 202d may indicate ability to accept challenging tasks and achieve goals within the sporting environment. Social ability 202e may indicate a player's ability to converse his requirements or desired goal in the sport with the coach, for example. Learning style may indicate a player's optimum learning style that enables the best outcome from the training. A person skilled in the art appreciates that the first set of elements may include additional aspects/elements other than the elements described herein. Such additional elements fall within the scope of the presently disclosed invention.

The second set of elements 204 may broadly categorize into direct impact elements or primary ecosystem 206 and indirect impact elements or secondary or fortifying ecosystem 208. The direct impact elements 206 may affect a player's performance immediately and change his performance significantly. The direct impact elements 206 may include, but not limited to, training 206a, free play 206b, game analysis 206c, fitness 206d, nutrition 206e, hydration 206f, recovery or rest 206g, sleep 206h, rest and so on. The training 206a includes any formal or informal training (or coaching) that the player receives. Formal training indicates training/coaching received from a coach or team member such as in a club, formal setup and so on. Informal training indicates self-learning or training without coach or advice from others, Free play 206b indicates the amount of time the player can spend playing the game without any supervision or coaching. Game analysis 206c indicates a player's ability analyze the game's rules and techniques involved. Fitness 206d indicates physical fitness of the player. Nutrition 206e indicates the diet the player's takes. The hydration 206f indicates replenishing fluids at regular intervals before, during and after every game as recommended by council of exercise. The recovery or rest 206g may indicate the activities that the player undertakes before and after a game of play/sport to get back to peak fitness again. The sleep 206h indicates the quantity and quality of the sleep of the player. A person skilled in the art appreciates that the second set of elements may include additional aspects/elements other than the elements described herein. Such additional elements fall within the scope of the presently disclosed invention.

The indirect impact elements 208 may indicate elements that influence a player's perception of the sport. The indirect impact elements 208 may include, but not limited to, parents 208a, friends or influencers 208b, role models 208c, school 208d, other sports 208e, other activities 208f, among others. Here, parents 208a indicate the parenting attitude and behavior that influence the development and performance in the game. Friends or influencers 208b indicate siblings or friends or peers who influence the player's game. Role Models 208c indicate successful players influencing the player's development in the game. School or college 208d may indicate the place where the player gets his/her education and influences his/her playing the sport. Other Sports 208e indicate the influence of participation in other sports to development in the game. Other activities 208f indicate all other non-sporting activities that influence the time and effort commitment to the game.

A person skilled in the art appreciates that the first set of elements 202 and second set of elements 204 presented herein are exemplary elements. Different elements may be added or deleted from the first set of elements 202 and second set of elements 204 described herein to assess performance and provide recommendations to the player without departing from the scope of the present invention.

The processor 112 presents the first set of elements 202 and the second set of elements 204 in series in the form of a questionnaire and prompts the user to provide his/her answers/responses. The system 110 presents a question in a variety of formats. For example, the system 110 presents a question in one of a dichotomous question, multiple choice questions, rank order scaling question, text slider question, Likert scale question, semantic differential scale, staple scale question, constant sum question or any other question format. User selects an appropriate answer and submits it to the system 110. The processor 112 receives an answer to each of the first set of elements and the second set of elements presented to the user and stores them in the main memory 114. The questionnaire can change with time. An exemplary questionnaire presented to the user on the user device 150 is shown in Table 1.

TABLE 1
A sample questionnaire that is answered by the Player/Parent.

| | | | Response | Response | Response |
|---|---|---|---|---|---|
| No | Question | Target | 1 | 2 | 3 |
| Q1 | What happens when you | Player | 1 [ ] | 2 [ ] | 3 [ ] |
| | play against tougher | | | | |
| | opponents or play in | | | | |
| | crucial matches? | | | | |
| Q2 | How does your child | Parent | 1 [ ] | 2 [ ] | |
| | communicate with new | | | | |
| | teammates? | | | | |

After receiving the responses from the player/parent, the system 110 assigns a score to each of the responses to the corresponding questionnaire. Exemplary scores assigned for the answers to the questionnaire presented to the players/parents is illustrated in Table 2.

TABLE 2
Structure and contents of an empirical database generated
from the answers to the Players Questionnaire

| | Player & Parent - | | | | | | |
|---|---|---|---|---|---|---|---|
| | Scores mapped | | | | | | |
| No | to each Player | Q1 | Q2 | Q3 | Q4 | Q5 | Q6 |
| 1 | John Smith | 8 | 3 | 32 | 45 | 80 | 44 |
| 2 | Kathy Parker | 62 | 41 | 81 | 75 | 85 | 100 |
| 3 | Anil Kumar | 31 | 39 | 36 | 90 | 75 | 49 |
| 4 | Abdul Hassan | 62 | 24 | 47 | 87 | 49 | 23 |
| 5 | Maya Goroti | 48 | 5 | 58 | 17 | 6 | 15 |

Here, the system 110 calculates the score for the feature as a function of the answers to one or more questions from the player/parent, TABLE 3 presents an exemplary calculation of feature score, in accordance with one embodiment of the present invention.

TABLE 3
Feature Score Calculation

| | |
|---|---|
| feature_1 = | f (Q1, Q2, Q3, Q4, . . . ) |
| feature_2 = | f (Q10, Q11, Q12, . . . ) |
| feature_3 = | f (Q21, Q22, Q23 . . . ) |

For each of the first set of elements 202 and the second set of elements 204, the system 110 assigns a weightage (i.e., weight). The weightage is assigned based on the effect an element may have on a player's ability to understand/follow and improve the skill. For example, the system 110 may assign a weightage of 100% or 1 to the element passion 202a. Further, the system 110 may assign a weightage of 105% or 1.05 to the element passion perseverance 202b. Further, the may assign a weightage of 100% or 1 to the element self-efficacy or self-control 202d. Similarly, the system 110 assigns weightage for each of the first set of elements 202 and the second set of elements 204.

After assigning the weightages, the system 110 maps the feature values of the players based on the weightages assigned. TABLE 4 illustrates the feature value for particular players corresponding to the weightages.

TABLE 4
Feature value for particular players corresponding to the weightages
Feature (Parameter) Mapping for Players

| | | Feature | Feature | Feature | Feature | Feature | Feature |
|---|---|---|---|---|---|---|---|
| No | Player | 1 | 2 | 3 | 4 | 5 | 6 |
| 1 | John Smith | 113 | 34 | 58 | 137 | 96 | 90 |
| 2 | Kathy Parker | 100 | 30 | 66 | 77 | 107 | 75 |
| 3 | Anil Kumar | 101 | 37 | 43 | 77 | 88 | 56 |
| 4 | Abdul Hassan | 92 | 35 | 48 | 122 | 85 | 63 |
| 5 | Maya Goroti | 90 | 20 | 30 | 70 | 50 | 45 |

After mapping the feature values of players, the system 110 calculates an elite comparison score (ECS) or benchmark score. Here, the system 110 calculates the ECS as a function of the features scores for each player against elite players taken as a benchmark or benchmark threshold. In accordance with the present invention, the system 110 calculates the ECS as Elite Comparison Score (EPS)=Total Score−distance from Elite Player. Further, the system 110 calculates the total score of ECS using the formula:

ECS(Total_Score)=f(feature_1,feature_2,feature_3, . . . )

Here, the system 110 uses machine learning techniques such as supervised and/or unsupervised learning techniques to calculate the scores. In one example the system 110 uses weighted average methods such as a simple and baseline adjusted discrete method to calculate the scores. In another example, the system 110 uses one of machine learning techniques such as cluster distance, cosine similarity, logistic regression, Support Vector Machines, and Random Forest to calculate the scores.

After calculating the ECS for each player, the system 110 presents the values of ECS for each of the players. TABLE 5 illustrates an example ECS value calculated for the players presented in the above examples (e.g., TABLE 2).

TABLE 5
Elite Comparison Score (ECS) values calculated fir players.
Elite Comparison Score (ECS) Mapping for Players

| No | Player | ECS |
|---|---|---|
| 1 | John Smith | 0.683 |
| 2 | Kathy Parker | 0.649 |
| 3 | Anil Kumar | 0.579 |
| 4 | Abdul Hassan | 0.476 |
| 5 | Maya Goroti | 0.393 |

Subsequently, the system 110 compares the players score with elite and non-elite players. Elite players indicate professional players whose performance or score are used as a benchmark. Non-elite players are non-professional players whose performance is considered as moderate or average with respect to the elite players. In the present invention, the system 110 uses one or more statistical analyses to compare the performance of the players with that of the elite and non-elite players. After comparison, the system 110 correlates the players on a scale of 0 to 1 with that of the elite and non-elite Players.

Based on the correlation of the players with that of the elite and non-elite players, the system 110 provides one or more recommendations for each of the first set of elements and the second set of elements to the user. In one implementation, the system 110 is configured with a recommendation algorithm to provide recommendations. The recommendation algorithm comprises one of machine learning and deep learning techniques. For example, the system 110 uses one of collaborative Filtering, Bayesian, K Nearest Neighbor, a logistic or linear regression and decision tree & random forest techniques to provide recommendations. In one implementation, the system 110 implements a machine learning model to train and validate data. The system 110 may train the data using one of supervised and unsupervised learning techniques. Alternatively, the system 110 may provide recommendations using neural network, artificial intelligence or any other technique known in the art and such implementations fall within the scope of the present invention. The system 110 provides the one or more recommendations in the form of a text or visual representation on the user device 150. The one or more recommendations may include, but not limited to, areas of improvement the user should focus on to improve his attitude, behavior, skill, training, timing and other elements before, during and after playing the sport. In one example, the system 110 presents the one or more recommendations corresponding to the responses received for each of the first set of elements 202 and the second set of elements 204 presented to the user. The user receives the recommendations and follows them to improve his play/game.

In one implementation, the system 110 presents the questionnaire to the users after a period of time, say one month after providing the recommendations. The system 110 receives the responses for the questionnaire corresponding to the first set of elements 202 and the second set of elements 204. The system 110 calculates the ECS and correlates the player's score with both elite and non-elite players. Here, the system 110 compares the performance or improvement of the player over the period of time and provides further recommendations to improve the game by the player. This way, the system 110 acts as a feedback system or coach for the player and ensures the player improves his skill and techniques of playing the game.

FIG. 4 shows a method 300 in which the system for assessing data corresponding to performance of a player playing a sport/game and providing recommendations for improving the performance is explained, in accordance with one exemplary embodiment of the present invention. The method 300 may be described in the general context of computer executable instructions. Generally, computer executable instructions may include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described and is not intended to be construed as a limitation, and any number of the described method blocks can be combined in any order to implement the method 300 or alternate methods. Additionally, player blocks may be deleted from the method 300 without departing from the spirit and scope of the invention described herein. Furthermore, the method may be implemented in any suitable hardware, software, firmware, or combination thereof. However, for ease of explanation, in the embodiments described below, the method 300 may be implemented in the above-described system 110.

At step 302, the system 110 prompts a user and presents a set of questionnaires corresponding to the first set of elements and second set of elements. The first set of elements and second set of elements correspond to the personality and ecosystem of a player playing/interested in a sport/game/play. The user provides responses using the user device 150. The system 110 receives the responses (step 304). At step 306, the system 110 maps each of the responses with predetermined parameters having weightages. At step 308, the system 110 determines a score for each of the first and second set of elements based on the mapping and assesses the skill, personality and ecosystem of the player. Further, the system 110 presents an aggregate score based on the score for each of the first set of elements and the second set of elements. At step 310, the system 110 provides recommendations to the user to improve the game based on the assessment.

The system helps to predict and develop players by identifying their weaknesses and strengths based on their personality and ecosystem as well as providing them with recommendations to improve in each area of weakness. The system helps to consider a variety of variables including, but not limited to, attitude, behavior of the players and many diverse elements in their sporting and non-sporting environment. This helps to determine a successful path to the sport in predicting and training reliable players.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in FIGUREs are provided for illustrative purposes only and should not be construed in a limited sense. A person skilled in the art will appreciate alternate components that may be used to implement the embodiments of the present invention and such implementations will be within the scope of the present invention.

What is claimed is:

1. A method of assessing data corresponding to performance of a user playing a sport and providing recommendations for improving the performance, the method comprising steps of:
presenting, by a processor, questionnaire to a user corresponding to first set of elements and second set of elements;
receiving, by the processor, responses for the first set of elements and second set of elements from the user via a user device;
mapping, by the processor, the responses with predetermined parameters, wherein the responses are mapped by assigning weightages for each of the predetermined parameters;
calculating, by the processor, a feature value of the user corresponding to the responses and the weightages assigned;
calculating, by the processor, a benchmark score of the user, wherein the benchmark score is calculated as a function of feature value of the user distant from an elite player in the sport;
correlating, by the processor, the benchmark score against a benchmark threshold to obtain deviation of the benchmark score from the benchmark threshold; and
providing, by the processor, recommendations to the user based on the deviations in order to improve performance of the game.

2. The method of claim 1, wherein the step of correlating comprising:
comparing the benchmark score with the benchmark threshold.

3. The method of claim 1, wherein the benchmark score is calculated using a supervised or unsupervised learning method.

4. The method of claim 1, wherein the first set of elements comprise passion, perseverance, ownership, self-control, social ability and learning style of the user.

5. The method of claim 1, wherein the second set of elements comprise training, game analysis, fitness, nutrition, hydration, rest, recovery, sleep, parenting practices, role models, and influencers.

6. A system for assessing data corresponding to performance of a user playing a sport and providing recommendations for improving the performance, the system comprising:
a processor; and
a memory coupled to the processor, wherein the processor is configured to execute program instructions stored in the memory, to:
present questionnaire to a user corresponding to a first set of elements and a second set of elements;
receive responses for the first set of elements and the second set of elements from the user via a user device;
map the responses with predetermined parameters, wherein the responses are mapped by assigning weightages for each of the predetermined parameters;
calculate a feature value of the user corresponding to the responses and the weightages assigned;
calculate a benchmark score of the user, wherein the benchmark score is calculated as a function of feature value of the user distant from an elite player in the sport;
correlate the benchmark score against a benchmark threshold to obtain deviation of the benchmark score from the benchmark threshold; and
provide recommendations to the user based on the deviations in order to improve performance of the game.

7. The system of claim 6, wherein the processor executes the program instructions to compare the benchmark score with the benchmark threshold.

8. The system of claim 6, wherein the benchmark score is calculated using a supervised or unsupervised learning method.

9. The system of claim 6, wherein the first set of elements comprise passion, perseverance, ownership, self-control, social ability and learning style of the user.

10. The system of claim 6, wherein the second set of elements comprise training, game analysis, fitness, nutrition, hydration, rest, recovery, sleep, parenting practices, role models, and influencers.

11. A non-transitory machine-readable storage medium having instructions stored thereon which, when executed by a processor of a system for assessing data corresponding to performance of a user playing a sport and providing recommendations for improving the performance, causes the system to perform operations comprising:
presenting questionnaire to a user corresponding to first set of elements and second set of elements;
receiving responses for the first set of elements and the second set of elements from the user via a user device;
mapping the responses with predetermined parameters, wherein the responses are mapped by assigning weightages for each of the predetermined parameters;
calculating a feature value of the user corresponding to the responses and the weightages assigned;
calculating a benchmark score of the user, wherein the benchmark score is calculated as a function of feature value of the user distant from an elite player in the sport;
correlating the benchmark score against a benchmark threshold to obtain deviation of the benchmark score from the benchmark threshold; and
providing recommendations to the user based on the deviations in order to improve performance of the game.

12. The non-transitory machine readable storage medium of claim 11, wherein the step of correlating comprising:
comparing the benchmark score with the benchmark threshold.

13. The non-transitory machine readable storage medium of claim 11, wherein the benchmark score is calculated using a supervised or unsupervised learning method.

14. The non-transitory machine readable storage medium of claim 11, wherein the first set of elements comprise passion, perseverance, ownership, self-control, social ability and learning style of the user.

15. The non-transitory machine readable storage medium of claim 11, wherein the second set of elements comprise training, game analysis, fitness, nutrition, hydration, rest, recovery, sleep, parenting practices, role models, and influencers.
